(19) United States
(12) Patent Application Publication
(10) Pub. No.: US 2023/0186055 A1
(43) Pub. Date: Jun. 15, 2023

(54) DECORRELATION MECHANISM AND DUAL NECK AUTOENCODER FOR DEEP LEARNING

(71) Applicant: Rensselaer Polytechnic Institute, Troy, NY (US)

(72) Inventors: Ge Wang, Loudonville, NY (US); Christopher Wiedeman, Troy, NY (US)

(73) Assignee: Rensselaer Polytechnic Institute, Troy, NY (US)

(21) Appl. No.: 18/081,156

(22) Filed: Dec. 14, 2022

Related U.S. Application Data
(60) Provisional application No. 63/432,188, filed on Dec. 13, 2022.
(60) Provisional application No. 63/289,225, filed on Dec. 14, 2021.

(51) Int. Cl. G06N 3/0455; G06N 3/094

(52) U.S. Cl. CPC G06N 3/0455; G06N 3/094

(57) ABSTRACT

In one embodiment, there is provided a dual neck autoencoder module for reducing adversarial attack transferability. The dual neck autoencoder module includes an encoder module configured to receive input data; a decoder module; and a first bottleneck module and a second bottleneck module coupled, in parallel, between the encoder module and the decoder module. The decoder module is configured to generate a first estimate based, at least in part, on a first intermediate data set from the first bottleneck module, and a second estimate based, at least in part, on a second intermediate data set from the second bottleneck module. The first intermediate data set and the second intermediate data set are at least partially decorrelated based, at least in part, on a correlation loss.

### CROSS REFERENCE TO RELATED APPLICATION(S)

This application claims the benefit of U.S. Provisional Application No. 63/289,225, filed Dec. 14, 2021, and U.S. Provisional Application No. 63/432,188, filed Dec. 13, 2022, which are incorporated by reference as if disclosed herein in their entireties.

### GOVERNMENT LICENSE RIGHTS

This invention was made with government support under award number CA237267, awarded by the National Institutes of Health (NIH). The government has certain rights in the invention.

### FIELD

The present disclosure relates to an autoencoder, in particular to, a decorrelation mechanism and dual neck autoencoder for deep learning.

### BACKGROUND

The advancement of artificial intelligence, especially deep learning (DL), has revolutionized research in computer vision, natural language processing, and other fields, including medical image reconstruction. Unfortunately, along with the advancement of artificial intelligence, has been the development of adversarial attacks against deep learning models. For example, it has been shown that adding deliberately crafted but imperceivable perturbations to MNIST (Modified National Institute of Standards and Technology) digit images could cause a trained classifier to misclassify the sample. Successful adversarial attacks have been demonstrated in other DL contexts, including, for example, speech-to-text translation and medical image reconstruction. Counterintuitively, networks that can generalize to never-seen natural samples may not perform well on samples very close to previously seen samples. Such a discovery not only raises security concerns but also questions whether DL models truly learn the desired features for a given task.

### SUMMARY

In some embodiments, there is provided a dual neck autoencoder module for reducing adversarial attack transferability. The dual neck autoencoder module includes an encoder module configured to receive input data; a decoder module; and a first bottleneck module and a second bottleneck module coupled, in parallel, between the encoder module and the decoder module. The decoder module is configured to generate a first estimate based, at least in part, on a first intermediate data set from the first bottleneck module, and a second estimate based, at least in part, on a second intermediate data set from the second bottleneck module. The first intermediate data set and the second intermediate data set are at least partially decorrelated based, at least in part, on a correlation loss.

In some embodiments of the dual neck autoencoder module, the encoder module, the decoder module, the first bottleneck module and the second bottleneck module are trained. The training includes minimizing a cost function that includes a correlation loss function. The correlation loss function is related to a first feature set produced by the first bottleneck module, and a second feature set produced by the second bottleneck module.

In some embodiments of the dual neck autoencoder module, each module includes an artificial neural network.

In some embodiments of the dual neck autoencoder module, the cost function includes a first mean square error associated with the first bottleneck module, and a second mean square error associated with the second bottleneck module.

In some embodiments, there is provided a method for reducing adversarial attack transferability. The method includes receiving, by a dual neck autoencoder module, input data. The dual neck autoencoder module includes an encoder module, a decoder module, and a first bottleneck module and a second bottleneck module coupled, in parallel, between the encoder module and the decoder module. The method further includes generating, by the decoder module, a first estimate based, at least in part, on a first intermediate data set from the first bottleneck module, and a second estimate based, at least in part, on a second intermediate data set from the second bottleneck module. The first intermediate data set and the second intermediate data set are at least partially decorrelated based, at least in part, on a correlation loss.

In some embodiments, the method further includes training, by a training module, the dual neck autoencoder module. The training includes minimizing a cost function that includes a correlation loss function. The correlation loss function is related to a first feature set produced by the first bottleneck module, and a second feature set produced by the second bottleneck module.

In some embodiments, the method further includes determining an output, by a classifier module, based, at least in part, on the first estimate and based, at least in part, on the second estimate.

In some embodiments of the method, each module comprises an artificial neural network.

In some embodiments of the method, the correlation loss function is:

[symbol]

_{R}=log(SSₜₒₜₐₗ+ε)−log(SSᵣₑₛ+ε)

[symbol]

_{R}=log(∥Z₂∥₂²+ε)−log(∥(I−(Z₁^{T}Z₁)⁻¹Z₁^{T})Z₂∥₂²+2

In some embodiments, the method further includes generating, by the training module, training data based, at least in part, on a surrogate adversarial model.

In some embodiments of the method, the cost function includes a first mean square error associated with the first bottleneck module, and a second mean square error associated with the second bottleneck module.

In some embodiments of the method, the training includes optimizing a classification based objective.

In some embodiments, there is provided dual neck autoencoder system for reducing adversarial attack transferability. The dual neck autoencoder system includes a computing device, and a dual neck autoencoder module. The computing device includes a processor, a memory, an input/output circuitry, and a data store. The dual neck autoencoder module includes an encoder module, a decoder module, and a first bottleneck module and a second bottleneck module coupled, in parallel, between the encoder module and the decoder module. The dual neck autoencoder module is configured to receive input data. The decoder module is configured to generate a first estimate based, at least in part, on a first intermediate data set from the first bottleneck module, and a second estimate based, at least in part, on a second intermediate data set from the second bottleneck module. The first intermediate data set and the second intermediate data set are at least partially decorrelated based, at least in part, on a correlation loss.

In some embodiments, the system further includes a training module configured to train the dual neck autoencoder module. The training includes minimizing a cost function that includes a correlation loss function. The correlation loss function is related to a first feature set produced by the first bottleneck module, and a second feature set produced by the second bottleneck module.

In some embodiments, the system further includes a classifier module configured to determine an output based, at least in part, on the first estimate and based, at least in part, on the second estimate.

In some embodiments of the system, each module includes an artificial neural network.

In some embodiments of the system, the correlation loss function is:

[symbol]

_{R}=log(SSₜₒₜₐₗ+ε)−log(SSᵣₑₛ+ε)

[symbol]

_{R}=log(∥Z₂∥₂²+ε)−log(∥(I−(Z₁^{T}Z₁)⁻¹Z₁^{T})Z₂∥₂²+2

In some embodiments of the system, the training module is configured to generate training data based, at least in part, on a surrogate adversarial model.

In some embodiments of the system, the cost function includes a first mean square error associated with the first bottleneck module, and a second mean square error associated with the second bottleneck module.

In some embodiments of the system, the training includes optimizing a classification based objective.

In some embodiments, there is provided a computer readable storage device. The device has stored thereon instructions that when executed by one or more processors result in the following operations including any embodiment of the method.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 illustrates a functional block diagram of a dual neck autoencoder system that includes a dual neck autoencoder module for reducing adversarial attack transferability, according to several embodiments of the present disclosure;

FIGS. 2A through 2C are functional block diagrams of example artificial neural network (ANN) architectures according to an embodiment of the dual neck autoencoder module of FIG. 1;

FIG. 2D is a functional block diagram of example ANN architecture according to an embodiment of the classifier module of FIG. 1; and

FIG. 3 is a flowchart of operations for training a dual neck autoencoder system, according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to an autoencoder, in particular to, a decorrelation mechanism and dual neck autoencoder for deep learning. It is contemplated that transferability between seemingly different models may be due to a relatively high linear correlation between feature sets extracted by different neural networks. A feature correlation loss, according to the present disclosure, is configured to decorrelate the extracted features in a latent space. The feature correlation loss is configured reduce the transferability of adversarial attacks between models (i.e., artificial neural networks (ANNs)), suggesting that the models complete tasks in semantically different ways. In an embodiment, a Dual Neck Autoencoder (DNA) is configured to leverage the feature correlation loss to create two meaningfully different encodings of input information with reduced transferability.

By way of theoretical background, as used herein, an untargeted adversarial attack is an attack that does not seek a specific result (e.g., misclassification into a specific class) aside from maximally degrading a performance measure of a model, e.g., artificial neural network (ANN). If f is a trained model, with a loss objective J(θ, x, y), where θ are the model parameters and {x, y} are data inputs and labels (i.e., target outputs), respectively, then an untargeted attack based on sample/label pair {xᵢ, yᵢ} may be configured to find point xᵢ′near xᵢ that maximizes a loss:

$${x}_{i}^{′} = {argmax}_{{x}_{i} ′} J ( θ , {x}_{i}^{′} , {y}_{i} ) , D ( {x}_{i} , {y}_{i}^{′} ) \leq ϵ$$

where D is a distance metric, and ϵ is a constraint on the distance metric. In one nonlimiting example, the norm L_{∞}(xᵢ−xᵢ′) may be used for D. It may be appreciated that the L_{∞}norm is a commonly used distance metric in adversarial attacks. However, this disclosure is not limited in this regard and other norms, e.g., L₀, L₁, L₂, may be used, within the scope of the present disclosure.

An apparatus, method, and/or system, according to the present disclosure includes a decorrelating mechanism and Dual Neck Autoencoder architecture for breaking adversarial attack transferability in deep neural networks. Existence of adversarial attack transferability is well-recognized in deep learning. Research literature has partially explained transferability by recognizing common adversarial subspaces and correlations between decision boundaries. It is contemplated that transferability between seemingly different models may be due to a high linear correlation between respective feature sets extracted by each different network. Herein, “network”, “model”, “ANN”, and “neural network” (NN) are used interchangeably, and all refer to an artificial neural network that has an appropriate network architecture. Network architectures may include one or more layers that may be sparse, dense, linear, convolutional, and/or fully connected. It may be appreciated that deep learning includes training an ANN. Each ANN may include, but is not limited to, a deep NN (DNN), a convolutional neural network (CNN), a deep CNN (DCNN), a multilayer perceptron (MLP), etc. Training generally corresponds to “optimizing” the ANN, according some a defined metric, e.g., minimizing a cost (e.g., loss) function.

In an embodiment, a feature correlation loss is configured to decorrelate the extracted features in a latent space, resulting in a reduction in the transferability of adversarial attacks between models. It may be appreciated that this reduction in transferability suggests that the models complete tasks in semantically different ways. In an embodiment, a Dual Neck Autoencoder (DNA) is configured to leverage the feature correlation loss to create two meaningfully different encodings of input information with a reduced transferability.

It may be appreciated that an adversarial attack utilizes input data (“attack input data”) configured to increase a likelihood that a target ANN will produce a wrong result. Such attack input data may be generated using a variety of techniques. Fast Gradient Sign Method (FGSM) and Projected Gradient Descent (PGD) are two example techniques that may be used to generate attack input data. It may be further appreciated that attack input data may be used to test a robustness of an autoencoder architecture against attack. FGSM is relatively simple and relatively efficient. FGSM may be described as:

x′=x+ϵ sgn(∇ₓJ(θ,x,y))

PGD is similar to FGSM, but uses a random initialization and iteration to find relatively stronger attacks. Clipping is used to keep the sample within aa distance constraint and data range. PGD may be written as:

x^{t+1}=Clip(x^{t}+α sgn(∇ₓJ(θ,x,y)))

where α is a step size. PGD may be considered a relatively strong attack, and attaining robustness against PGD may generally defend against other attacks.

Adversarial attacks may be categorized as white, gray, or black box attacks where the “color” is configured to indicate an attacker's knowledge of the target model. In white box attacks, the attacker has full access to the model's architecture and parameters. In gray box attacks, the attacker only knows the model architecture. In black box attacks, it is assumed that the attacker has no information regarding the target model. In both gray and black box scenarios, an attacker typically trains a surrogate model as the target model, and then crafts attacks using this surrogate. While white box attacks are the most potent, gray and black box attacks have been also shown potency due to relatively high attack transferability between models.

An interesting property of adversarial attacks is their transferability between models, i.e., adversarial samples trained to target a selected model may be successful against other models, even when these models are trained with different data or use different architectures. Researchers have recognized attack transferability between models (especially among smaller models). It has been shown that deep neural networks (DNNs) may robust to random perturbations (e.g., Gaussian noise) while being relatively highly vulnerable to adversarial attacks. Thus, while many adversarial examples may exist, the total adversarial space is not random and may be small relative to a high dimensional input space. It may be appreciated that decision boundaries around samples may be correlated between different models, and that adversarial samples exist in subspaces that often intersect. This phenomenon may be observed in universal adversarial perturbations, which generalize not only between models, but also between different input samples due to relatively strong correlations between decision boundaries.

An apparatus, method, and/or system, according to the present disclosure, includes a mechanism configured to break attack transferability, including training two meaningfully different neural networks. It may be appreciated that a naïve approach would maximize the distance between two models in the parameter space, as it is known that DNNs typically do not converge to a global minimum. As an example, a relatively simple convolutional neural network (CNN) was designed for MNIST classification and two corresponding models, f₁ and f₂, were trained in parallel using a cross entropy (CE) loss while incentivizing various parameter distances (Frobenius norm) between their parameters, θ₁ and θ₂. After training the pair of networks, FGSM attacks of varying magnitude e were determined for one network and attack (i.e., input data having an associated incorrect classification result) transferability to the other network was tested. No correlation was found between transferability and distance in parameter space, contradicting the notion that parametrically distant networks solve tasks in different ways. Further investigation revealed a strong correlation between model hidden features, Z₁, Z₂. For example, if X∈ [symbol] ^{N×D} is a batch of N input samples, then Z₁, Z₂ ∈ [symbol] ^{N×M} correspond to vectorized hidden features of length M from the two models, respectively. It was discovered that Z₁ and Z₂ were relatable by a linear regression:

Z₂=Z₁W; Z₁=[Z₁,1]

where W is a matrix containing optimal regression weights using ordinary least squares.

Further investigation revealed that this relatively high degree of correlation not only held for natural samples, but also for adversarial samples, and was true regardless of the parametric distance between the two models, revealing a strong, consistent linear relationship between the two encodings. This finding is in line with observations from others, which note that individual units in latent spaces do not correspond to useful information; rather, vectors in the space as a whole represent features. This also suggests that DNNs distant in the parametric space may not be semantically different; rather, they can (and often do) encode the same information, only differing by trivial transformations in their latent spaces (e.g., rotations, expansions/contractions, shifts).

Given such a linear correlation between features extracted by networks, a question is how networks would behave if this correlation were disrupted. This scenario was evaluated by training two classifying CNNs in parallel, and including a decorrelating term [symbol] _{R} configures to decouple the latent features extracted by the two models:

J(θ₁,θ₂,x,y)=CE(f₁(θ₁,x),y)+CE(f₂(θ₂,x),y)+λ [symbol] _{R}(f₁,f₂,θ₁,θ₂,x)

The decorrelating term [symbol] _{R}, referred to as a correlation loss, corresponds to a correlation coefficient of features Z₁, Z₂, at a proper hidden layer in the neural networks. Implementing a log transform and inserting a small constant value ε (e.g., 0.001) may aid stability. In an embodiment, a correlation loss may be written as:

[symbol]

_{R}=log(SSₜₒₜₐₗ+ε)−log(SSᵣₑₛ+ε)

[symbol]

_{R}=log(∥Z₂∥₂²+ε)−log(∥(1−(Z₁^{T}Z₁)⁻¹Z₁^{T})Z₂∥₂²+ε)

where SSₜₒₜₐₗ is total sum of squares, SSᵣₑₛ is residual sum of squares, and I is the identity matrix.

It may be appreciated that, in some circumstances, Z₁ may not be full column rank. While a solution may exist for theoretically relatively more stable rank-deficient pseudo-inverse computations, a QR decomposition may be used to find dependent columns of Z₁ and remove them. Algorithm 1 illustrates one nonlimiting example of determining a correlation loss that includes a QR decomposition. However, this disclosure is not limited in this regard.

Algorithm 1. Computation of the correlation loss between latent features.

#N: batch size
#Z₁, Z₂ ∈ [symbol] ^{N×M}: vectorized batch features from two networks
#ε = 0.001: constant of stability
#η = 0.0005: criteria for determining independent columns
_, R = QR(Z₁) #QR decomposition
column_index = abs(diag(R)/max(diag(R)) >
η #find index of independent columns
Z₁ = [Z₁[:, column_index], 1] #remove dependent
columns and augment in 1s column
SSᵣₑₛ = ||(l − (Z₁ ^{T} Z₁)⁻¹ Z₁ ^{T}) Z₂||₂² #Residual sum
of squares from the OLS solution
SSₜₒₜₐₗ = ||Z₂||₂² #Total sum of squares [symbol]
_{R} = log(SSₜₒₜₐₗ + ε) − log(SSᵣₑₛ + ε)

In an experiment, transferability of trained CNN pairs with and without using correlation loss was evaluated. In one nonlimiting example, it was found that weighting [symbol] _{corr}(λ=0.05) was associated with a reduction in adversarial transferability over a range of tested magnitudes (e.g., ϵ=0.05, 0.10, 0.15). Stronger attacks were associated with a corresponding greater transferability. Imposing the correlation loss constraint had a relatively small effect on the natural sample, in one nonlimiting example, reducing accuracy to 94.875% from 97%.

In one embodiment, a Dual Neck Autoencoder (DNA), according to the present disclosure corresponds to a autoencoder/decoder structure that diverges into two paths at a most compressed hidden layer (i.e., the bottleneck). It may be appreciated that, in nature and communication systems, for example, information redundancy occurs or is purposely implemented. In other words, two differently processed but overlapping information representations may be encoded and decoded in parallel. Most of the architecture may be shared between encoding pathways, yet the pathways may be different. The shared architecture is configured to avoid having two separate models, while avoiding pathways with trivial differences (e.g., spatial rotations, shifts, etc.) that may suffer from identical instabilities.

In one embodiment, there is provided a dual neck autoencoder module for reducing adversarial attack transferability. The dual neck autoencoder module includes an encoder module configured to receive input data; a decoder module; and a first bottleneck module and a second bottleneck module coupled, in parallel, between the encoder module and the decoder module. The decoder module is configured to generate a first estimate based, at least in part, on a first intermediate data set from the first bottleneck module, and a second estimate based, at least in part, on a second intermediate data set from the second bottleneck module. The first intermediate data set and the second intermediate data set are at least partially decorrelated based, at least in part, on a correlation loss.

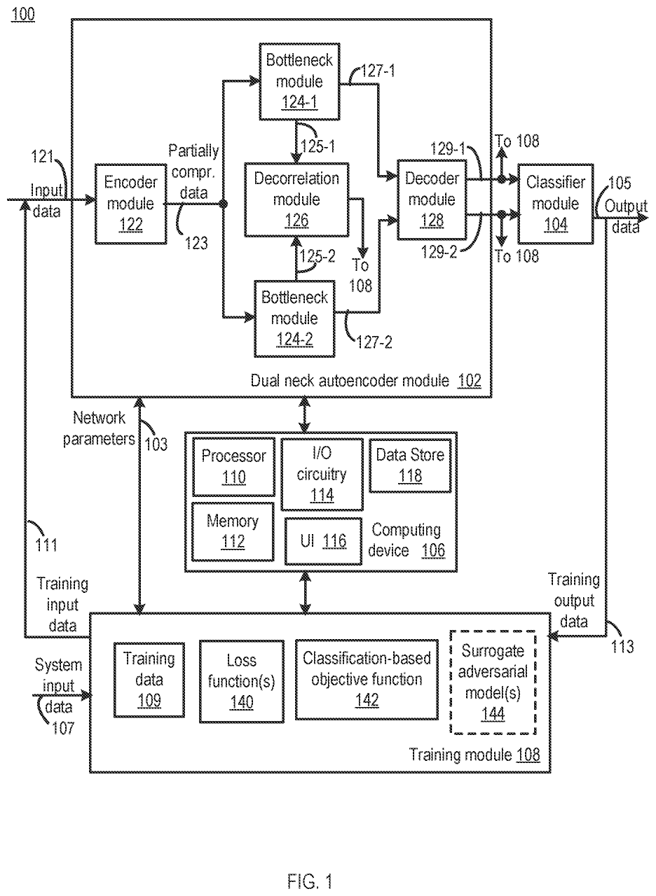

FIG. 1 illustrates a functional block diagram of a dual neck autoencoder system 100 that includes a dual neck autoencoder module 102 for reducing adversarial attack transferability, according to several embodiments of the present disclosure. The dual neck autoencoder system 100 includes the dual neck autoencoder module 102, a classifier module 104, a computing device 106, and may include a training module 108. The dual neck autoencoder module 102, classifier module 104, and/or training module 108 may be coupled to or included in computing device 106.

The dual neck autoencoder module 102 is configured to receive input data 121 and to provide a first estimate and a second estimate to the classifier module 104. Each estimate is configured to correspond to the input data. In one nonlimiting example, the first estimate may correspond to a first reconstructed data set and the second estimate may correspond to a second reconstructed data set, for example, in a classifier system. The classifier module 104 is configured to receive the two estimates and to provide corresponding output data 105, as will be described in more detail below.

Dual neck autoencoder module 102 includes an encoder module 122, a first bottleneck module 124-1, a second bottleneck module 124-2, a decorrelation module 126, and a decoder module 128. The bottleneck modules 124-1, 124-2 are coupled, in parallel, between the encoder module 122, and the decoder module 128. Each bottleneck module 124-1, 124-2 is configured to couple to the decorrelation module 126, e.g., during training.

Computing device 106 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Computing device 106 includes a processor 110, a memory 112, input/output (I/O) circuitry 114, a user interface (UI) 116, and data store 118.

Processor 110 is configured to perform operations of dual neck autoencoder module 102, classifier module 104, and/or training module 108. Memory 112 may be configured to store data associated with dual neck autoencoder module 102, classifier module 104 and/or training module 108. I/O circuitry 114 may be configured to provide wired and/or wireless communication functionality for dual neck autoencoder system 100. For example, I/O circuitry 114 may be configured to receive input data 121 and/or system input data 107 (including, e.g., training data 109) and to provide output data 105. UI 116 may include a user input device (e.g., keyboard, mouse, microphone, touch sensitive display, etc.) and/or a user output device, e.g., a display. Data store 118 may be configured to store one or more of system input data 107, training data 109, input data 121, output data 105, training output data 113, network parameters 103, and/or other data associated with dual neck autoencoder module 102, classifier module 104 and/or training module 108. Other data may include, for example, function parameters (e.g., related to loss function(s) 140, classification-based objective function 142, surrogate adversarial model(s) 144), training constraints (e.g., number of epochs, convergence criteria, etc.), etc.

Training module 108 may be configured to receive and store system input data 107. System input data 107 may include training data 109, loss function(s) 140 parameters, classification-based objective function 142 parameters, surrogate adversarial model(s) 144 parameters, etc. Training input data 109 may include, for example, a plurality of training data samples that include an input data sample, and a corresponding output data sample, i.e., label. In one nonlimiting example, the training data may correspond to at least a portion of the MINST data set. Training module 108 may be further configured to receive and/or store one or more loss function(s) 140, a classification-based objective function 142, and/or one or more surrogate adversarial model(s) 144, as described herein.

The encoder module 122 is configured to receive input data 121, e.g., input image data, and to at least partially compress the input data 121 to produce corresponding partially compressed data 123. Each bottleneck module 124-1, 124-2 is configured to receive the partially compressed data 123. Each bottleneck module 124-1, 124-2 is configured to further compress the partially compressed data 123 to produce respective compressed data sets 125-1, 125-2. For example, the first bottleneck module 124-1 is configured to produce a first compressed data set 125-1, and the second bottleneck module 124-2 is configured to produce a second compressed data set 125-2. Each compressed data set corresponds to a respective latent space feature set. Each bottleneck module 124-1, 124-2 is configured to provide its respective feature set 125-1, 125-2 to the decorrelation module 126.

Each bottleneck module 124-1, 124-2 is further configured to partially decompress its respective feature set 125-1, 125-2 to produce a respective intermediate data set 127-1, 127-2. For example, the first bottleneck module 124-1 is configured to partially decompress the first feature set 125-1 to produce a first intermediate data set 127-1, and the second bottleneck module 124-2 is configured to partially decompress the second feature set 125-2 to produce a second intermediate data set 127-2.

The decoder module 128 is configured to receive each intermediate data set 127-1, 127-2, and to decompress the received intermediate data sets 127-1, 127-2 to produce respective estimates 129-1, 129-2. In one nonlimiting example, each respective estimate may correspond to a respective reconstructed data set. The reconstructed data sets 129-1, 129-2 may then be received by the classifier module 104. The classifier module 104 may then be configured to produce output data 105 based, at least in part, on the reconstructed data sets 129-1, 129-2.

Thus, for dual neck autoencoder system 100, a common encoder and a common decoder may be shared configured to compress and decompress information, respectively. Two separate bottleneck modules are configured to differently encode information into fully compressed states which may then be decorrelated using a correlation loss term. The decoder is configured to produce a separate reconstruction from each encoding.

In operation, the shared encoder module 122 is configured to first process and partially compress the input data 121. The encoded, i.e., partially compressed data may then be provided to the two bottleneck modules 124-1, 124-2, each of which is configured to further compress the information before partially decompressing. During training, the latent representations at the most compressed state are compared between the two bottlenecks using the correlation loss. The two partial decompressions are then both fully decompressed with a common decoder 128, producing two separate reconstructions 129-1, 129-2. In an embodiment, a trained classifier 104 may be configured to evaluate the reconstructions.

The dual neck autoencoder module 102 may be trained prior to operation. Generally, training operations include providing training input data 111 to dual neck autoencoder module 102, capturing training output data 113 corresponding to output image data from dual neck autoencoder module 102, evaluating a cost function, and adjusting network parameters 103 to optimize the network parameters 103. In one nonlimiting example, optimizing may correspond to minimizing the cost function. The network parameters 103 may be related to one or more of encoder module 122, bottleneck modules 124-1, 124-2, and/or decoder module 126, as will be described in more detail below. Training operations may repeat until a stop criterion is met, e.g., a cost function threshold value is achieved, a maximum number of iterations has been reached, etc. At the end of training, network parameters 103 may be set for operation. The dual neck autoencoder module 102 may then be configured to be somewhat resistant to adversarial attack.

In an embodiment, the DNA module 102 may be trained for reconstruction fidelity with dual neck autoencoder loss function (J_{DNA}):

J_{DNA}(F,Z,xᵢ)=MSE(F(xᵢ,θ)₁,xᵢ)²+MSE(F(xᵢ,θ)₂,xᵢ)²+λ [symbol] _{R}(F,θ,xᵢ)

where MSE is the mean square error between two arguments, F(·)ₙ is the nₜₕ reconstruction pathway (e.g., encoder→bottleneckₙ→decoder), xᵢ is an input batch of images, and θ=[θ_{encoder}, θ_{bottelneck1}, θ_{bottleneck2}, θ_{decoder}] are the network parameters. It may be appreciated that the correlation loss, L_{R}(F, θ, xᵢ), is configured to use the compressed bottleneck representations 125-1, 125-2 for correlation comparison. It should be noted that, if the correlation loss is disregarded, the dual neck autoencoder loss function is the squared L₂ norm of the mean-square errors of the two reconstructions. The squared L₂ norm is configured to avoid a “sparse” solution, i.e., avoid improving one reconstruction at the expense of the other.

It may be appreciated that a goal in testing a dual neck autoencoder system, according the present disclosure, is to generate adversarial attacks and observe whether the architecture (i.e., divergent structure and decorrelation mechanism) can break transferability between the two reconstructions. Attacks targeting the mean square error of either reconstruction may result in added background noise in the output rather than differences in semantic content (e.g., causing the autoencoder to reconstruct a perceptually different digit). As such, a classifier, C, (e.g., classifier module 104) may be added after the DNA, having a classification based objective:

J(F,C,xᵢ)=CE(C(F(xᵢ,θ)₁),yᵢ)²+CE(C(F(xᵢ,θ)₂),yᵢ)²

The classification-based objective may corresponds to a squared L₂ norm of the cross-entropy losses from the two reconstructions from the two paths. It may be appreciated that the squared L₂ norm is favored over the Lᵢ norm to avoid a sparse solution where only one loss is maximized. As such, the classification-based objective is configured to consider both bottlenecks simultaneously, searching for intersections between the two adversarial spaces.

Thus, a dual neck autoencoder system, according to the present disclosure, may be configured to resist attach transferability.

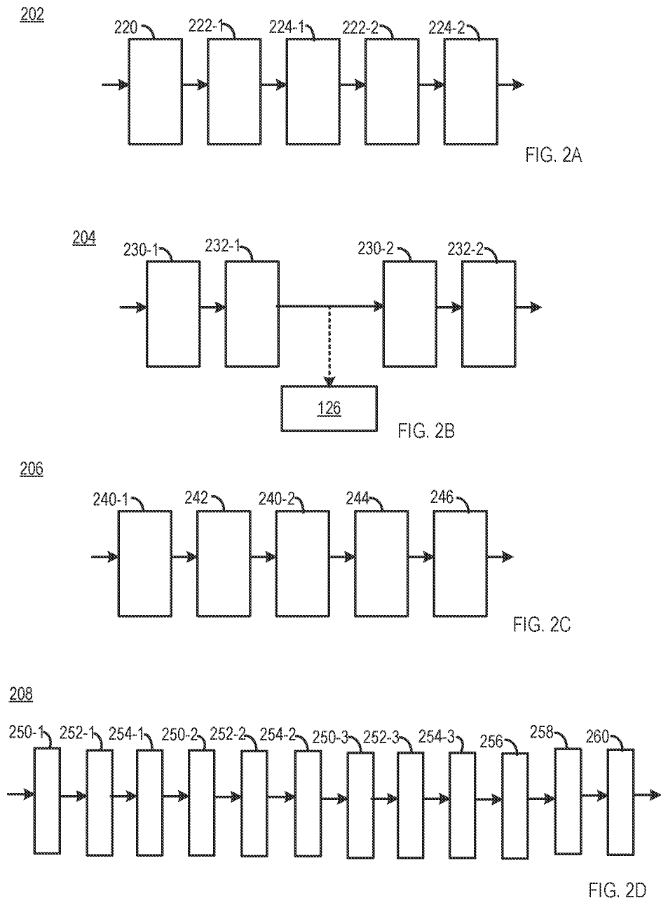

FIGS. 2A through 2C are functional block diagrams 202, 204, and 206, respectively, of example ANN architectures, according to an embodiment of the dual neck autoencoder module 102 of FIG. 1. FIG. 2D is a functional block diagram 208 of an example ANN architecture, according to an embodiment of the classifier module 104 of FIG. 1. FIG. 2A is a functional block diagram 208 of an example ANN according to an embodiment of the classifier module 104 of FIG. 1. FIGS. 2A through 2D may be best understood when considered together, and together with FIG. 1. FIG. 2A is one example of the encoder module 122, FIG. 2B is one example of the bottleneck modules 124-1, 124-2, and FIG. 2C is one example of the decoder module 126, all of FIG. 1. FIGS. 2A through 2D may be best understood when considered together.

Turning first to FIG. 2A, the example encoder module 202 includes a flatten stage 220, a first densely connected layer 222-1 (e.g., with size 100), a first rectified linear unit (ReLU) 224-1, a second densely connected layer 222-2 (e.g., with size 128), and a second ReLU 224-2. The example encoder module 202 is configured to receive input data 121, to partially compress the received input data, to provide as output partially compressed data 123.

Turning now to FIG. 2B, the example bottleneck module 204 corresponds to bottleneck modules 124-1, 124-2. Example bottleneck module 204 includes a first linear densely connected layer 230-1 (e.g., with size 64), a first ReLU 232-1, a second linear densely connected layer 230-2 (e.g., with size 128), and a second ReLU 232-2. Example bottleneck module 204 is configured to couple to the decorrelation module 126 between the first ReLU 232-1 and these second linear densely connected layer 230-2. Each bottleneck module 204 is configured to receive the output of the encoder module, i.e., partially compressed data 123, to further compress the received data 123 to produce respective compressed data set 125-1, 125-2 that may then be provided to the decorrelation module 126. Each bottleneck module 204 is further configured to partially decompress the respective compressed data set to generate a respective intermediate data set that may then be provided to the decoder module 128.

Turning now to FIG. 2C, the example decoder module 206 corresponds to decoder module 128 of FIG. 1. The example decoder module 206 includes a first linear densely connected layer 240-1 (e.g., with size 100), an ReLU 242, a second linear densely connected layer 240-2 (e.g., with size 28²), a sigmoid layer 244, and a reshape layer 246. The example decoder module 206 is configured to receive each intermediate data set 127-1, 127-2 from each respective bottleneck module, and to generate a corresponding respective estimate 129-1, 129-2.

Turning now to FIG. 2D, the example classifier module 208 corresponds to classifier module 104 of FIG. 1. The example classifier module 208 includes three convolutional stages 250-1, 250-2, 250-3. Each convolutional stage includes a 3×3, one-stride, zero padded two dimensional (2D) convolutional layer with a number, K, output filters. In this example, a first convolutional stage 250-1 includes 8 output filters, a second convolutional stage 250-2 includes 16 output filters, and a third convolutional stage 250-3 includes 32 output filters. The example classifier module 208 further includes three ReLUs 252-1, 252-2, 252-3. The example classifier module 208 further includes three pooling layers 254-1, 254-2, 254-3, with 2×2 maximum pooling. The example classifier module 208 further includes a flatten stage 256, a densely connected layer 258 and a softmax stage 260.

Continuing with the example classifier module 208, the first convolutional stage 250-1 is configured to receive the reconstructed data sets 129-1, 129-2 from the decoder module 128, and the softmax stage 260 is configured to provide the output data 105. An order of the elements of the example classifier module 208, in this example, is the first convolutional stage 250-1 followed by a first ReLU 252-1 followed by a first pooling layer 254-1, followed by the second convolutional stage 250-2, followed by a second ReLU 252-2, followed by a second pooling layer 254-2 followed by the third convolutional stage 250-3 followed by a third ReLU 252-3 followed by a third pooling layer 254-3 followed by the flatten stage 256 followed by the densely connected layer 258, and finally followed by the softmax layer 260.

It may be appreciated that modules 202, 204, 206, and 208 correspond to one example neural network architecture for each module. Other network architectures may be implemented, within the scope of the present disclosure.

Turning again to FIG. 1, the dual neck autoencoder module 102 may be trained prior to operation. Generally, training operations include providing training input data 111 to dual neck autoencoder module 102, capturing training output data 113 corresponding to output image data from dual neck autoencoder module 102, evaluating a cost function, and adjusting network parameters 103 to optimize the network parameters 103. In one nonlimiting example, optimizing may correspond to minimizing the cost function. The network parameters 103 may be related to one or more of encoder module 122, bottleneck modules 124-1, 124-2, and/or decoder module 126, as will be described in more detail below. A cost function associated with the dual neck autoencoder architecture, according to the present disclosure, includes a correlation loss. Training operations may repeat until a stop criterion is met, e.g., a cost function threshold value is achieved, a maximum number of iterations has been reached, etc. At the end of training, network parameters 103 may be set for operation. The dual neck autoencoder module 102 may then be configured to be somewhat resistant to adversarial attack.

For training, initially system input data 107 may be received by dual neck autoencoder system 100, e.g., by training module 108. The system input data 107 may include, for example, training data 109, as described herein. The system input data 107 may further include one or more loss functions, including a correlation loss, a classification based objective function, and/or surrogate adversarial models, as described herein. The training data may include, for example, a plurality of training data pairs, with each pair including an input sample and a corresponding target output sample, i.e., label. In one nonlimiting example, the training data may include an associated probability density function.

The training data may then be applied the dual neck autoencoder module 102 and/or classifier module 104. For example, the training module 108 may be configured to provide a selected training input data sample as input data 121, and may then be configured to capture one or more outputs from the dual neck autoencoder module 102, and/or classifier module 104. For example, the decorrelation module 126 may be configured to evaluate a correlation loss function, [symbol] _{R}, as described herein. The decoder module 128 may be configured to provide the first and second estimates 129-1, 129-2 to the training module 108. The training module 108 may be configured to evaluate the DNA loss function, J_{DNA}, as described herein, for reconstruction fidelity, based, at least in part on the correlation loss and based, at least in part, on the first and second estimates. In another example, the classifier module 104 may be configured to evaluate a classification based objective function, as described herein. These evaluations may be performed based, at least in part, on outputs from decorrelation module 126, decoder module 128 and classifier module 104.

For example, a training input data sample may be applied to the dual neck autoencoder module 102. The encoder module 122 may receive the training input data sample, and may then partially compress the input data. The partially compressed data 123 may then be received by the bottleneck modules 124-1, 124-2, that may then further compress the partially compressed data to generate respective compressed data sets (i.e., respective latent space feature sets) 125-1, 125-2. Both respective feature sets 125-1, 125-2 may then be applied to and received by the decorrelation module 126. The decorrelation module 126 may then determine a corresponding correlation loss, as described herein. Each bottleneck module 124-1, 124-2 may further partially decompress each compressed data set to produce respective intermediate data sets 127-1, 127-2. The intermediate data sets may then be provided to decoder module 128. Decoder module 128 may then be configured to decompress each respective intermediate data set to yield respective estimates 129-1, 129-2. In one nonlimiting example, the estimates may correspond to reconstructed data sets. Training module 108 is configured to receive the correlation loss, the compressed data sets, the estimates 129-1, 129-2, to evaluate one or more of the loss functions, and to adjust the network parameters 103 to optimize the loss functions.

The estimates 129-1, 129-2 may be provided to the classifier module 104. The classifier module 104 may then be configured to generate training output data 113. Network parameters associated with the classifier module 104 may then be adjusted to optimize the classification based objective function 142.

At the completion of training, the network parameters 103 may then be set based, at least in part, on the training results. The dual neck autoencoder module 102 and classifier module 104 may then be ready for use. During use, input data 121 may be provided to the dual neck autoencoder module 102, and corresponding output data 105 may be generated by classifier module 104 based, at least in part, on estimates 129-1, 129-2 generated by dual neck autoencoder module 102. It may be appreciated, that the dual neck autoencoder architecture that includes the bottleneck modules 124-1, 124-2 coupled in parallel between the encoder module 122 and decoder module 128, may provide relatively more resistance to an adversarial attack than an autoencoder without the dual neck architecture.

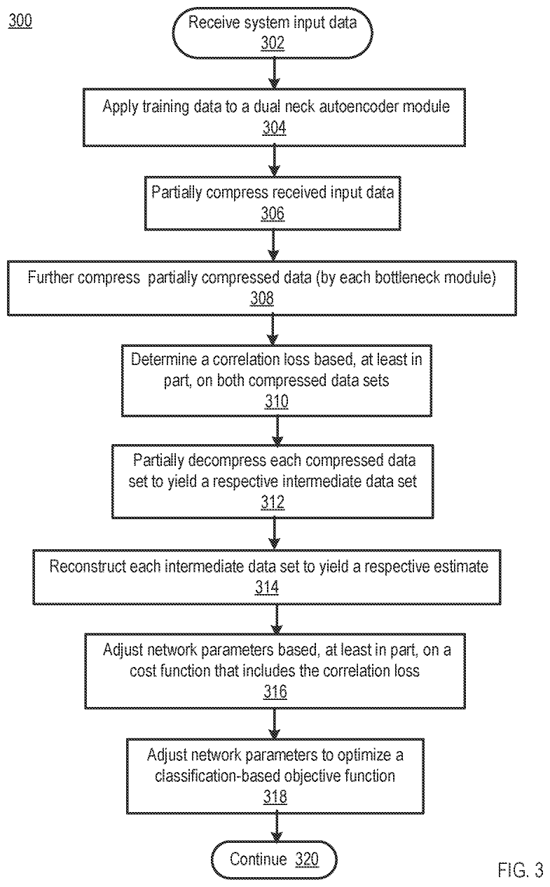

FIG. 3 is a flowchart 300 of operations for training a dual neck autoencoder system, according to an embodiment of the present disclosure. In particular, the flowchart 300 illustrates training a dual neck autoencoder module. The operations may be performed, for example, by the dual neck autoencoder system 100 (e.g., dual neck autoencoder module 102, classifier module 104, and/or training module 108) of FIG. 1.

Operations of this embodiment may begin with receiving system input data at operation 302. The system input data may include training data. Training data may be applied to a dual neck autoencoder module at operation 304. Operation 306 includes partially compressing received input data. Operation 308 includes further compressing partially compressed data by each bottleneck module. Operation 310 includes determining a correlation loss based, at least in part, on both compressed data sets. Operation 312 includes partially decompressing each compressed data set to yield a respective intermediate data set. Each intermediate data set may be reconstructed to yield a respective estimate at operation 314. Network parameters may be adjusted based, at least in part, on a cost function that includes the correlation loss at operation 316. In some embodiments, network parameters may be adjusted to optimize a classification-based objective function at operation 318. Program flow may then continue at operation 320.

Thus, a dual neck auto encoder system may be trained. The dual neck autoencoder system may include a correlation loss function, configured to degrade transferability of an adversarial attack.

In an experiment, a dual neck autoencoder system, according to the present disclosure was trained, as described herein. A weighting parameter λ for the correlation loss, in the dual neck autoencoder loss function (J_{DNA}), was set to 0.05. Experimental results of the DNA system were compared to a traditional autoencoder of a comparable architecture (i.e., an identically designed encoder, single bottleneck, and decoder in series, with no correlation loss mechanism). A sample reconstruction was considered accurate if one or both output reconstructions were correctly classified. Classification metrics (i.e., accuracy (%) versus attack magnitude, ε, 0.0<ε<0.15) for DNA reconstructions of MNIST digit data under FGSM and PGD attacks were determined. All reconstruction accuracies decreased with higher magnitude attacks, with PGD attack being more potent. The DNA system performed relatively better compared to the traditional autoencoder.

Overall, results in these experiments indicate a reconstruction stability benefit from the decorrelated dual bottlenecks in the DNA system, according to the present disclosure. Although the encoder and decoder are shared in the DNA architecture, decoupling between paired bottlenecks creates a meaningful difference between the two reconstruction pathways. Adversarially attacking both pathways is relatively more difficult, even in a white-box scenario.

It is contemplated that a variety of scaling challenges may be considered for relatively more complex tasks. Adversarial attacks become more effective as input dimension increases.

Complex input domains with high variances over more subspaces may be relatively more difficult to compress in a small latent space. Implementing the correlation loss utilizes both QR decomposition and pseudo-inverse computation, both of which are achieved with singular value decomposition (SVD) in most deep learning toolboxes. The batch size determines the number of data points used when finding the pseudo-inverse. The batch size may be greater than the bottleneck size to avoid an under-constrained condition. Generally, the batch size may be significantly greater than the bottleneck size to avoid overfitted solutions.

It may be appreciated that a method, according to the present disclosure illustrates decreasing transferability of adversarial attacks found using common first-order methods, adversarial robustness is not guaranteed. Many attacks, particularly those with higher magnitude may transfer. It is contemplated that linearly decorrelating the latent features at some point in the models may decrease intersection of adversarial subspaces.

It is contemplated that correlational loss may be leveraged in a black-box or grey box setting. For example, a surrogate model may be traditionally trained, and then a deployable model may be trained for the same task with a feature correlation loss imposed between the fixed surrogate and the deployment model. It is presumed that a black box attack may be optimized to a model like the surrogate. It is contemplated that an ensemble of networks trained with a correlation loss may be configured to detect adversarial attacks, since it is less likely that these models would reach a consensus on adversarial samples.

Generally, this disclosure relates to an autoencoder, in particular to, a decorrelation mechanism and dual neck autoencoder for deep learning. It is contemplated that transferability between seemingly different models may be due to a relatively high linear correlation between feature sets extracted by different neural networks. A feature correlation loss, according to the present disclosure, is configured to decorrelate the extracted features in a latent space. The feature correlation loss is configured reduce the transferability of adversarial attacks between models (i.e., ANNs), suggesting that the models complete tasks in semantically different ways. In an embodiment, a Dual Neck Autoencoder (DNA) is configured to leverage the feature correlation loss to create two meaningfully different encodings of input information with reduced transferability.

As used in any embodiment herein, the terms “logic” and/or “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. The logic and/or module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory 112 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A dual neck autoencoder module for reducing adversarial attack transferability, the dual neck autoencoder module comprising:
an encoder module configured to receive input data;
a decoder module; and
a first bottleneck module and a second bottleneck module coupled, in parallel, between the encoder module and the decoder module,
the decoder module configured to generate a first estimate based, at least in part, on a first intermediate data set from the first bottleneck module, and a second estimate based, at least in part, on a second intermediate data set from the second bottleneck module,
wherein the first intermediate data set and the second intermediate data set are at least partially decorrelated based, at least in part, on a correlation loss.

2. The dual neck autoencoder module of claim 1, wherein the encoder module, the decoder module, the first bottleneck module and the second bottleneck module are trained, the training comprising minimizing a cost function that comprises a correlation loss function, the correlation loss function related to a first feature set produced by the first bottleneck module, and a second feature set produced by the second bottleneck module.

3. The dual neck autoencoder module of claim 1, wherein each module comprises an artificial neural network.

4. The dual neck autoencoder module of claim 2, wherein the cost function comprises a first mean square error associated with the first bottleneck module, and a second mean square error associated with the second bottleneck module.

5. A method for reducing adversarial attack transferability, the method comprising:
receiving, by a dual neck autoencoder module, input data, the dual neck autoencoder module comprising an encoder module, a decoder module, and a first bottleneck module and a second bottleneck module coupled, in parallel, between the encoder module and the decoder module; and
generating, by the decoder module, a first estimate based, at least in part, on a first intermediate data set from the first bottleneck module, and a second estimate based, at least in part, on a second intermediate data set from the second bottleneck module,
wherein the first intermediate data set and the second intermediate data set are at least partially decorrelated based, at least in part, on a correlation loss.

6. The method of claim 5, further comprising training, by a training module, the dual neck autoencoder module, the training comprising minimizing a cost function that comprises a correlation loss function, the correlation loss function related to a first feature set produced by the first bottleneck module, and a second feature set produced by the second bottleneck module.

7. The method of claim 5, further comprising determining an output, by a classifier module, based, at least in part, on the first estimate and based, at least in part, on the second estimate.

8. The method of claim 5, wherein each module comprises an artificial neural network.

9. The method of claim 6, wherein the correlation loss function is: [symbol]
_{R}=log(SSₜₒₜₐₗ+ε)−log(SSᵣₑₛ+ε) [symbol]
_{R}=log(∥Z₂−Z̅₂∥₂²+ε)−log(∥(1−Z₁(Z₁^{T}Z₁)⁻¹Z₁^{T})Z₂∥₂²+ε).

10. The method of claim 6, further comprising generating, by the training module, training data based, at least in part, on a surrogate adversarial model.

11. The method of claim 6, wherein the cost function comprises a first mean square error associated with the first bottleneck module, and a second mean square error associated with the second bottleneck module.

12. The method of claim 7, wherein the training comprises optimizing a classification based objective.

13. A dual neck autoencoder system for reducing adversarial attack transferability, the system comprising:
a computing device comprising a processor, a memory, an input/output circuitry, and a data store; and
a dual neck autoencoder module comprising an encoder module, a decoder module, and a first bottleneck module and a second bottleneck module coupled, in parallel, between the encoder module and the decoder module,
the dual neck autoencoder module configured to receive input data, the decoder module configured to generate a first estimate based, at least in part, on a first intermediate data set from the first bottleneck module, and a second estimate based, at least in part, on a second intermediate data set from the second bottleneck module,
wherein the first intermediate data set and the second intermediate data set are at least partially decorrelated based, at least in part, on a correlation loss.

14. The system of claim 13, further comprising a training module configured to train the dual neck autoencoder module, the training comprising minimizing a cost function that comprises a correlation loss function, the correlation loss function related to a first feature set produced by the first bottleneck module, and a second feature set produced by the second bottleneck module.

15. The system of claim 13, further comprising a classifier module configured to determine an output based, at least in part, on the first estimate and based, at least in part, on the second estimate.

16. The system of claim 13, wherein each module comprises an artificial neural network.

17. The system of claim 14, wherein the correlation loss function is: [symbol]
_{R}=log(SSₜₒₜₐₗ+ε)−log(SSᵣₑₛ+ε) [symbol]
_{R}=log(∥Z₂−Z̅₂∥₂²+ε)−log(∥(1−Z₁(Z₁^{T}Z₁)⁻¹Z₁^{T})Z₂∥₂²+ε).

18. The system of claim 14, wherein the training module is configured to generate training data based, at least in part, on a surrogate adversarial model.

19. The system of claim 14, wherein the cost function comprises a first mean square error associated with the first bottleneck module, and a second mean square error associated with the second bottleneck module.

20. The system of claim 15, wherein the training comprises optimizing a classification based objective.
